(19) United States
(12) Patent Application Publication
(10) Pub. No.: US 2017/0178191 A1
(43) Pub. Date: Jun. 22, 2017

(54) Validating Geolocation Data

(71) Applicant: Blis Media Limited, London (GB)

(72) Inventors: Gregor Donald ISBISTER, London (GB); Davide ANASTASIA, London (GB); Elena YEGOROVA, Greenhithe (GB); Guy NEEDHAM, London (GB)

(21) Appl. No.: 15/451,810

(22) Filed: Mar. 7, 2017

Related U.S. Application Data
(63) Continuation-in-part of application No. 15/336,023, filed on Oct. 27, 2016.
Application No. 15/336,023 is a continuation of application No. 13/857,338, filed on Apr. 5, 2013, now abandoned.

(30) Foreign Application Priority Data
Apr. 5, 2012 (GB) 12 06 254.3

(51) Int. Cl. G06Q 30/02; H04W 4/02

(52) U.S. Cl. CPC G06Q 30/0261; H04W 4/02; G06F 17/3087

(57) ABSTRACT

Validation of geolocation data received via an Internet Protocol (IP) network is shown. Advertisement requests are received from publishers connected to the IP network, and comprise the identity of the publisher and geolocation data of a device requesting a resource from the publisher over the IP network. A map procedure parses the advertisement requests to construct a first table having records indexed by the identity of the publisher and values that are at least the geolocation data. A reduce procedure reads the first table and performs tests on the values stored in it. A second table is then constructed having records indexed by the identity of the publisher and values that indicate whether the publisher is trusted or not. A publisher is trusted if each one of the plurality of tests is passed for all of the records in the first table corresponding to that publisher.

### CROSS REFERENCE TO RELATED APPLICATIONS

This application is a continuation-in-part of U.S. application Ser. No. ______ filed ______ (Attorney Docket No. 4113-P102-US-2), which is a continuation of U.S. application Ser. No. 13/857,338 filed Apr. 5, 2013 (now abandoned), and which claim priority from United Kingdom Patent App. No. 12 06 254.3 filed Apr. 5, 2012, now United Kingdom Patent No. 2 500 936. The whole contents of each of the above-identified applications are incorporated herein by reference in their entirety.

### BACKGROUND OF THE INVENTION

### 1. Field of the Invention

This invention relates to validating geolocation data received via an Internet Protocol (IP) network.

### 2. Description of the Related Art

Location-based services are becoming increasingly commonplace methodologies for delivering content to users, particular those who use mobile devices. In particular, publishers (also known as content providers) commonly wish to provide users with more relevant content in view of their current location—examples of such content being bespoke, dynamically-generated copy specific to a particular location, and advertising. For instance, a publisher may produce regional or even city-based news stories, and may wish to know a users present location such that they are presented with relevant news. Advertising may need to be presented on a location-specific basis—it would be no good, say, for a user browsing a web page in a first city to be presented with advertising for events occurring in a second city.

Whilst many mobile devices are now location-aware, which is to say they have Global Positioning System (GPS) or similar functionality, and can therefore generate geolocation data, only a small fraction actually give up this data to third parties.

It is therefore desirable to take measures to associate geolocation data with other data that is always provided by mobile devices.

### BRIEF SUMMARY OF THE INVENTION

The present invention is directed towards the validation of geolocation data received via an Internet Protocol (IP) network. In the method of the present invention, advertisement requests are received via the IP network, each of which is received from a respective publisher connected to the IP network. Each advertisement request comprises the identity of the publisher, and geolocation data comprising the latitude and longitude of a device requesting a resource from the publisher over the IP network.

A map procedure is then performed that includes parsing the advertisement requests to construct a first table having records indexed by the identity of the publisher and values that are at least the geolocation data.

This then allows a reduce procedure to be performed that includes reading the first table and performing tests on the values stored in it. A second table is then constructed with records indexed by the identity of the publisher and values that indicate whether the publisher is trusted or not.

In the present invention, a publisher is trusted if each of the tests is passed for all of the records in the first table corresponding to that publisher.

### BRIEF DESCRIPTION OF THE DRAWINGS

FIG. 1 shows an environment in which the present invention can be used;

FIG. 2 is an illustration of the scarcity of requests from browsing clients that contain geolocation data;

FIG. 3 shows a Real Time Bidding (RTB) environment;

FIG. 4 shows an example of an apparatus for implementing the present invention;

FIG. 5 shows procedures carried out by the RTB computer 401;

FIG. 6 shows the software components used to implement step 505;

FIG. 7 shows the tests in configuration file 604; and

FIG. 8 shows procedures carried out by the reducer 603.

### DETAILED DESCRIPTION OF EXAMPLE EMBODIMENTS

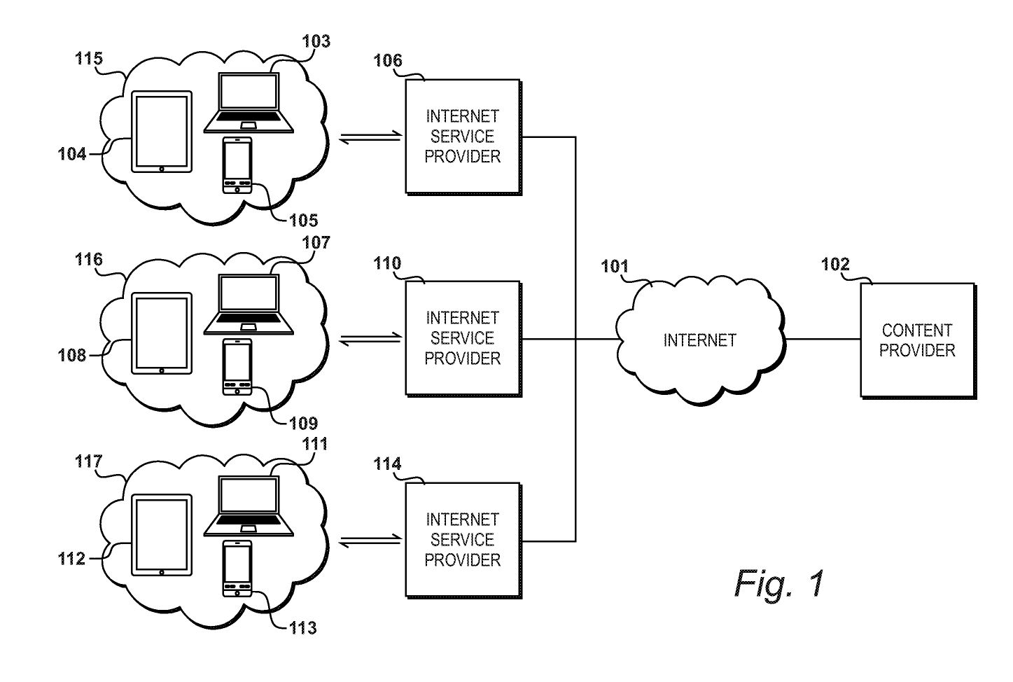

### FIG. 1

An exemplary environment in which the present invention may be used is illustrated in FIG. 1.

Connected by an Internet Protocol (IP) network such as the Internet 101, are a publisher 102, which provides web content such as web pages, videos and images, and a number of client devices. Each client device, in this case, is connected via an Internet service provider (ISP) using wireless networking technologies, such as 802.11b/g. Thus, client devices 103, 104 and 105 are connected to the Internet 101 by means of ISP 106; client devices 107, 108 and 109 are connected to the Internet 101 by means of ISP 110; and client devices 111, 112 and 113 are connected to the Internet 101 by means of ISP 114. In this example, each of ISPs 106, 110 and 114 provides Internet access to connected client devices at a particular location. Thus, client devices 103, 104 and 105 may be connecting to ISP 106 at a hotel, for instance. This type of service is commonly referred to as a “wireless hotspot”, and thus creates wireless hotspots 115, 116 and 117, with ISPs offering Internet access to client devices so as to allow web browsing, email access and so on. In this example, ISP 106 provides Internet access to client devices at a location distinct from ISP 110, ISP 110 provides Internet access to client devices at a location distinct from ISP 114, and so on.

There has recently become a demand for location-aware content. For instance, users may wish to receive content that is only relevant to them in their present location. Furthermore, publishers themselves may only wish to provide particular content to client devices at particular locations. A further need for location-aware generation of content exists in terms of not providing content to users in particular locations, thus allowing a greater degree of control over the distribution of content.

The present invention has a particular aim in the sort of scenario illustrated in FIG. 1: to enable more fine-grained provision of location-specific content to more users.

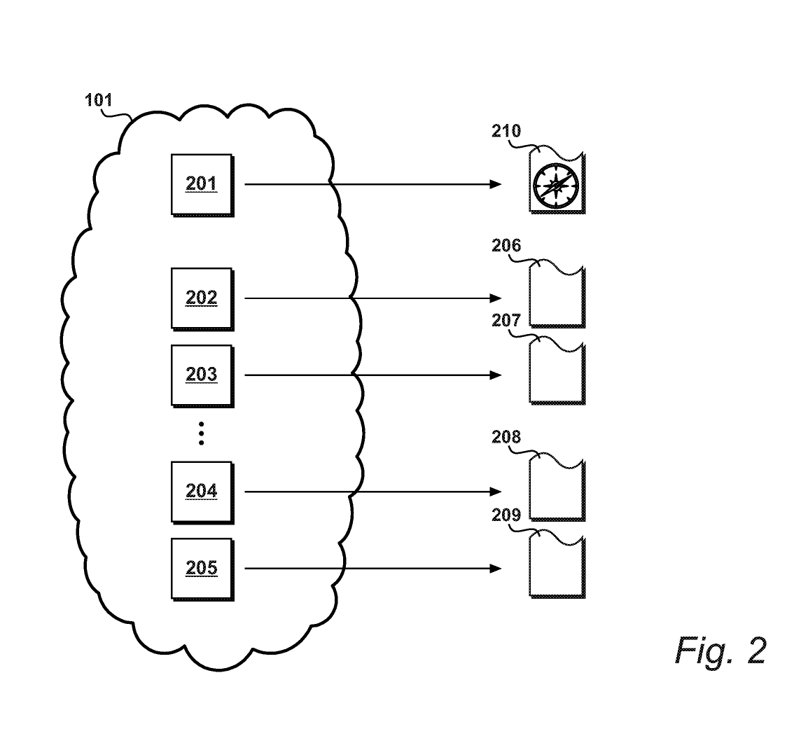

### FIG. 2

As will be appreciated by those skilled in the art, not all client devices have functionality that allows the provision, to a publisher, of their present location. FIG. 2 illustrates this problem diagrammatically.

A number of devices 201, 202, 203, 204 and 205 form part of the Internet 101, each possibly being connected to a wireless hotspot, such as those described previously with respect to FIG. 1. Each one of these devices sends out requests whenever they require data of some form—for example, they may be requesting an initial webpage HTML document using HTTP, or may, having received that HTML document, be requesting further resources required to display the webpage correctly, such as images, video or advertising.

Most of these requests, such as request 206 issued by device 202, request 207 issued by device 203, request 208 issued by device 204, and request 209 issued by device 205, contain only information concerning the Internet-facing IP address of the client device, the device type, the browser type and so forth. However, (as found in research conducted by the present applicant), in around five percent of cases, requests may include geolocation data, such as request 210 issued by device 201. Device 201 can therefore be characterised as a locatable browsing client. In many cases, this geolocation data comprises latitude and longitude co-ordinates generated by GPS-based technology present in the device. Other geolocation data that can be provided includes orientation (provided by a magnetometer or a compass) and altitude (either provided by GPS or an altimeter).

Thus, at first sight, it may seem, therefore, that only five percent of requests can be responded to with content that is sympathetic to a device's location.

However, the present applicant has recognised that in the case of ISP-owned wireless hotspot, such as those operated in the context of FIG. 1 by ISPs 106, 110 and 114, location-aware content can be provided to any and all client devices. Each wireless hotspot, such as wireless hotspots 115, 116 and 117, utilises some form of router to allow its connected client devices to access the Internet 101. Such routers often utilise Network Address Translation, such that devices connected on the local area network side of the router, whilst each having a distinct Internet Protocol (IP) address, appear from the wide area network side of the router to have the same IP address—the IP address of the router. Thus, referring to FIG. 1, it is clear from this knowledge that each one of the devices 103, 104 and 105 that are connected to ISP 106 will, from the perspective of publisher 102, appear to have the distinct originating IP address of the router operating the wireless hotspot operated by ISP 106. As the router is practically guaranteed to remain in a particular location, it is possible to therefore associate a particular location with a particular IP address, irrespective if the requests from the client devices themselves actually include geolocation data.

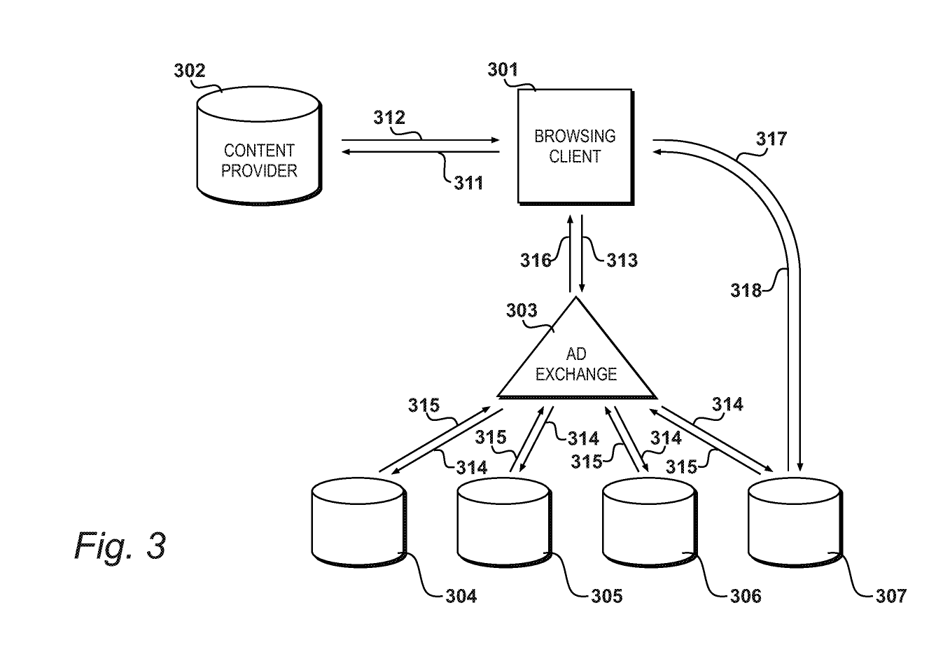

### FIG. 3

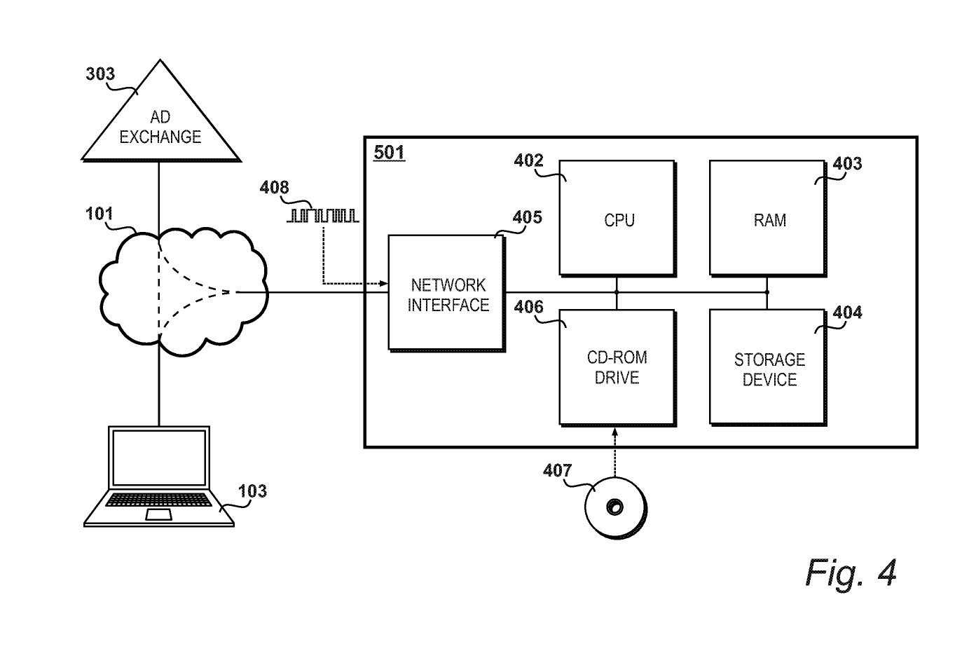

In the present embodiment, this is achieved by operating a computer within a Real Time Bidding environment for advertising, as shown in FIG. 3. The constituent components of such a computer will be expanded upon with reference to FIG. 4.

As will be appreciated by those skilled in the art, Real Time Bidding is a method of selling and purchasing advertising for display on a web page or within an application. This selling and purchasing is done in real time, and on a per-impression basis. Referring to FIG. 3, the way in which this operates will now be described.

A browsing client 301 makes a request at 311 for some content, such as a web page, from a publisher 302. The publisher supplies the HTML (or similar) for the web page to the browsing client at 312. Included in the code of the web page, is a pointer (known in the art as an “ad tag”) to resource hosted by an advertising exchange 303. Thus, at 313, the browsing client makes an advertisement request to the advertising exchange for the resource—i.e. the image or video to show as part of an advertisement on the web page. Importantly, this advertisement request to the advertising exchange includes data concerning the identity of the client and the publisher, and, as described previously with reference to FIG. 2, in a small proportion of cases this includes geolocation data.

After receiving this request, the advertising exchange 303 forwards the advertising requests at 314 to each one of a number of participants in the Real Time Bidding Environment—namely participants 304, 305, 306 and 307. This allows the participants to make an informed choice on the potential value of the advertising impression they are about to bid on. Each participant thus makes a decision as to whether to bid on the opportunity to present their advertising to the browsing client, and return their responses at 315. In this example, participant 307 wins the auction, and so advertising exchange 303 returns to browsing client 301 at 316 the location of a resource hosted by participant 307. At 317, browsing client 301 requests the resource (i.e. the data constituting an advertisement) from participant 307, which serves the data to the browsing client at 318.

### FIG. 4

Illustrated in FIG. 4 is an example of a computer apparatus that can be used by a participant in the Real Time Bidding environment described previously with reference to FIG. 3.

Thus, in this second embodiment, the apparatus is adapted to operate as a Real Time Bidding (RTB) computer 401. Upon receiving an advertising request from advertising exchange 303, appropriate bids on the advertising impression can be made by RTB computer 401.

In order for RTB computer 401 to execute instructions, it comprises a processor such as central processing unit (CPU) 402. In this instance, CPU 402 is a single multi-core Intel® Xeon® processor. It is possible that in other configurations several such CPUs will be present to provide a high degree of parallelism in the execution of instructions.

Memory is provided by eight gigabytes of DDR3 random access memory (RAM) 403, which allows storage of frequently-used instructions and data structures by RTB computer 401. A portion of RAM 403 is reserved as shared memory, which allows high speed inter-process communication between applications running on RTB computer 401.

Permanent storage is provided by a storage device such as hard disk drive 404, which in this instance has a capacity of one terabyte. Hard disk drive 404 stores operating system and application data. In alternative embodiments, a number of hard disk drives could be provided and configured as a RAID array to improve data access times, and the hard disk drive could be substituted with a solid-state disk.

A network interface 405 allows RTB computer 401 to connect to the Internet 101, possibly via an internal network and a router (not shown), and provide advertising content to a browsing client, such as client device 103 previously referenced with respect to FIG. 1, and also to receive advertising requests from advertising exchange 303. It will be appreciated that some of these advertising requests, as explained with reference to FIG. 2 and FIG. 3, will include geolocation data in addition to just the browsing client's IP address and identity of the publisher, etc. Network interface 405 also allows an administrator to interact with and configure web server 401 via another computer using a protocol such as secure shell.

RTB computer 401 also comprises an optical drive, such as a CD-ROM drive 406, into which an optical disk, such as a CD-ROM 407 can be inserted. CD-ROM 407 comprises computer-readable instructions that are installed on hard disk drive 404, loaded into RAM 403 and executed by CPU 402. Alternatively, the instructions (illustrated as 408) may be transferred from a network location using network interface 405. The instructions, when executed by the RTB computer 401, cause it to carry out the methods of the present invention.

It is to be appreciated that the above system is merely an example of a configuration of system that can fulfil the role of RTB computer 401. Any other system having a processor, memory, and a network interface could equally be used. Indeed, RTB computer 401 could be deployed as a virtual appliance on a virtualization platform hypervisor.

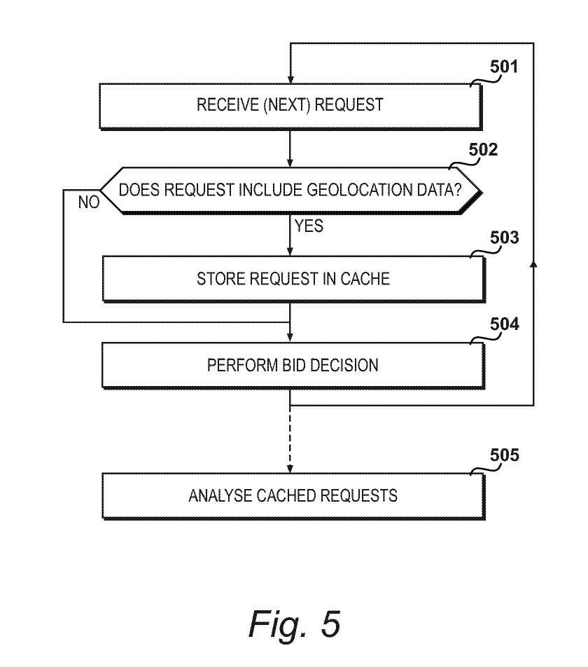

### FIG. 5

As described previously, the present invention is directed towards validating geolocation data received from publishers. This is because there is no guarantee that the data that publishers supply can be relied upon. This could potentially result in an incorrect association of a particular location with a particular IP address.

Procedures carried out by RTB computer 501, following the loading of instructions onto them, are illustrated in FIG. 5. These particular procedures allow the validation of geolocation data supplied by publishers.

At step 501, an advertising request is received, identifying the publisher, a unique identifier for the device, and possibly geolocation data for the device, i.e. its latitude and longitude co-ordinates.

At step 502, a question is asked as to whether the advertising request received at step 501 did comprise geolocation data. If so, then at step 503 the request is stored on the hard disk 404 in a cache.

At step 504, a bid decision is made in the known manner, and the process repeats itself until, on a periodic basis, an analysis step 505 is performed on the cached advertising requests. In the present embodiment, analysis step 505 is carried out once a day, but alternatively could be carried out more frequently or more infrequently.

In the context of RTB computer 401, the request received will be the data concerning the browsing client from an advertising exchange, which may include geolocation data as previously described.

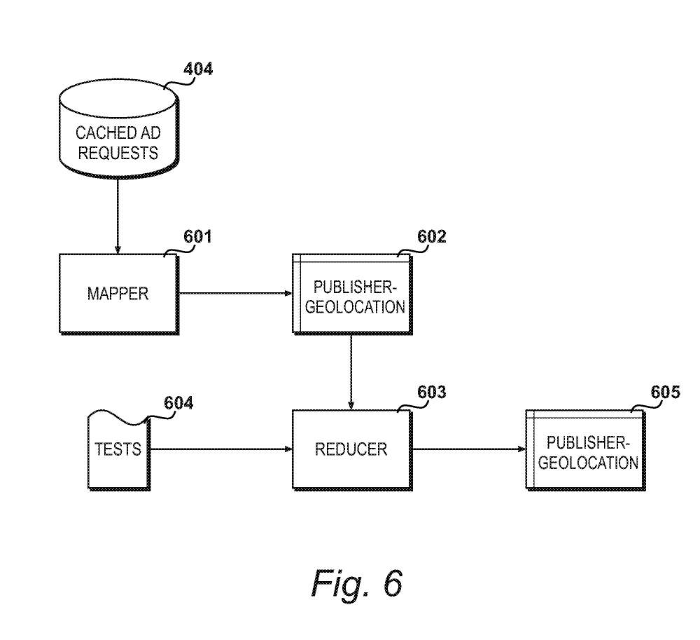

### FIG. 6

A block diagram of the software components used in the analysis step 505 is shown in FIG. 6.

The cached advertisement requests stored during step 503 are supplied from the hard disk drive 404 to a mapper 601. The mapper 601 runs on the CPU 402 and is configured to perform a map procedure that parses the advertisement requests to produce a table 602, which is saved to hard disk drive 404.

The table 602 is indexed by the identity of a publisher in an advertisement request, and has values that are at least the corresponding geolocation data (i.e. the latitude and longitude) from that advertisement request.

In the present embodiment, additional values are provided. In particular, advertisement requests tend to also include the country of origin in addition to their geolocation data, and so the map procedure thus includes those in table 602.

Furthermore, the mapper 601 is in the present embodiment configured to ignore advertisement requests that have a null publisher, and to ignore advertisement requests in which the latitude-longitude pair in the geolocation data is invalid (e.g. greater than 90 degrees latitude).

Thus, the table 602 parsed out of the cached advertisement requests is read from hard disk drive 404 by a reducer 603. The reducer 603 is operative to perform a reduce procedure that involves reading the table 602, and performing tests on the values in it. The tests are stored in a configuration file 604, which is read in by the reducer 603 at runtime.

The results of the tests are stored in a second table 605 which is indexed by unique publishers, and has values indicating whether publishers are validated or not. A publisher is trusted if each one of the tests in the configuration file 604 is passed for all of the records in the table 602 corresponding to that publisher.

It will be noted by those skilled in the art that the “mapper” and “reducer” components may be subsumed in the MapReduce framework for making the processing of the large dataset achievable in a short period. Thus, in an embodiment the function of the reducer 603 is carried out by distributed processing system in parallel.

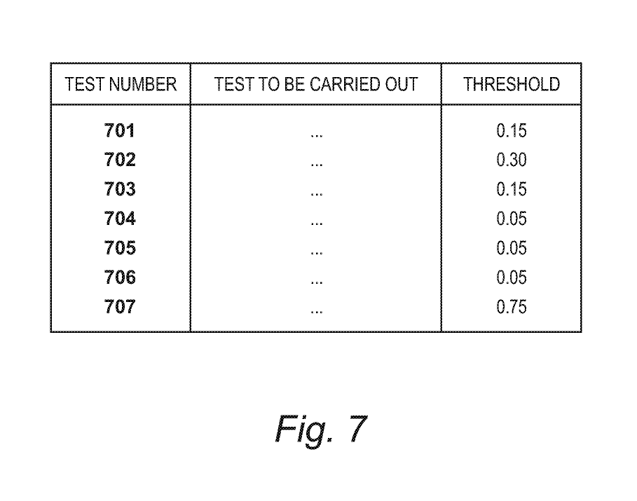

### FIG. 7

The tests defined in the configuration file 604 are shown in FIG. 7. The tests define a question to be answered by the reducer 603, and a configurable threshold which defines the criterion or threshold to be met for the statistic measured by each test.

A first test 701 comprises identifying whether the country identified in an advertising request matches the actual country as defined by the geolocation data.

In the present example, the actual country is identified by performing a lookup of the latitude and longitude comprised within the geolocation data using a country polygon cache stored in RAM 403. This allows the geolocation data provided by a publisher to be verified.

Thus in the first test 701, a count is made by the reducer 603 on a per-publisher basis of the number of countries in a publisher's advertisement requests that do not correspond to the country defined by the latitude and longitude in the geolocation data. In the present embodiment, 15 percent or fewer mismatches are permitted. Any more, and the publisher is not validated.

A second test 702 comprises making a count on a per-publisher basis of the number of instances where the geolocation data in an advertising request does not resolve in the aforementioned lookup to any country at all, i.e. the latitude and longitude data suggest that the request originated offshore.

In the present embodiment, a publisher passes the second test if 30 percent or fewer of the geolocation data in its advertisement requests do not correspond to any country. Any more, and the publisher is not validated.

A third test 703 comprises swapping the latitude and longitude values in the geolocation data. This swapped geolocation data is then used in the aforementioned lookup, giving an actual country that the swapped geolocation data correspond to for comparison with the countries supplied in the advertisement requests.

In the present embodiment, a publisher passes the third test if 15 percent or fewer of the actual countries identified using swapped geolocation data match the countries supplied in its advertisement requests. Any more, and the publisher is not validated.

A fourth test 704 comprises making an assessment on a per-publisher basis as to whether, for each of its advertisement requests, the geolocation data correspond to the centre of the actual country the geolocation data correspond to.

In the present embodiment, a publisher passes the fourth test if 5 percent or fewer of the geolocation data in its advertisement requests correspond to the centre of the actual country the geolocation data correspond to. Any more, and the publisher is not validated.

A fifth test 705 comprises assessing each record in the table 602 to identify whether the geolocation data correspond to either the equator or the Greenwich meridian.

In the present embodiment, a publisher passes the fifth test if 5 percent or less of the geolocation data in its advertisement requests do not correspond to either the equator or the Greenwich meridian. Any more, and the publisher is not validated.

A sixth test 706 comprises assessing each record in the table 602 to identify whether the latitude and longitude in the geolocation data are symmetric.

In the present embodiment, a publisher will pass the sixth test 706 if 5 percent or less of the latitude and longitude in the geolocation data are symmetric. Any more, and a publisher will not be validated.

A seventh test 707 comprises assessing each record in the table 602 by counting the decimal places in the geolocation data to assess its accuracy.

In the present embodiment, a publisher will pass the seventh test 707 if 75 percent or more of the geolocation data in its advertisement requests have at least 3 decimal places. Any less, and it will not be validated.

As described previously, each advertisement request includes a unique device identifier that identifying the particular device from which the advertisement request originated. An eighth test 708 therefore comprises counting the number of unique identifiers in the table 602.

In the present embodiment a publisher passes the eighth test 708 if there is more than one unique identifier, and there are more than 100 records that have different geolocation data and have an identifier.

A ninth test 709 comprises inspecting the name of the publisher in each record in table 602. A publisher will fail this ninth test 709 if it contains a string “vpn”. This is because such publishers are known to route network traffic from one location to another, and thus cannot be trusted to provide real location information, even if they pass the other eight tests.

It should be noted that the above thresholds for determining whether a publisher passes at test may be varied depending upon the accuracy required.

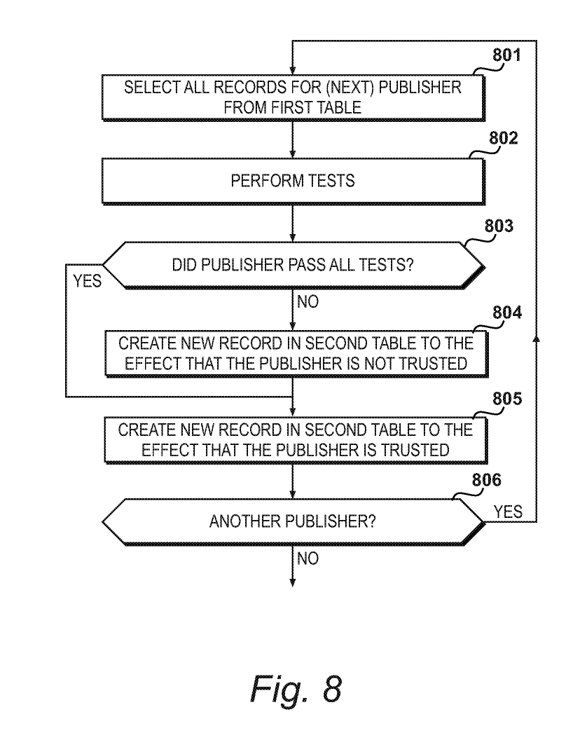

### FIG. 8

Steps carried out by the reducer 603 to validate publishers are shown in FIG. 8.

At step 801, all of the records in table 602 for a distinct publisher are selected for consideration, enabling the tests set out in the configuration file 604 to be performed by the reducer 603 at step 802. A question is then asked at step 803 as to whether the publisher under consideration passed all of the tests demanded by the configuration file. If not, then a record is created in the table 605 at step 804 in which the identity of the publisher is the key, and the value reflects the fact that it is not trusted as it failed at least one test.

If all tests 701 to 709 are passed, then a publisher may be considered trusted. Thus at step 805, a record is in the table 605 in which the identity of the particular publisher is the key, and the value reflects the fact that it is trusted as it passed all of the tests.

Finally, a question is asked at step 806 as to whether there is another distinct publisher to consider in the table 602. If so, control returns to step 801. If not, then the reducer's job is complete and the analysis step 505 is complete.

This means that geolocation data that is delivered in advertising requests originating from it may be relied upon, and may be correlated with the originating IP addresses of the advertising requests to facilitate the serving of location-specific content. Without the tests performed by the reducer 603, there would be no certainty that publishers were supplying accurate data in their advertisement requests, which could lead to errors being made.

1. A method comprising validating geolocation data received via an Internet Protocol (IP) network, the method comprising:
receiving a plurality of advertisement requests via the IP network, each one of which is received from a respective one of a plurality of publishers connected to the IP network, and wherein each of the plurality of advertisement requests comprises at least the identity of the publisher, and geolocation data comprising the latitude and longitude of a device requesting a resource from the publisher over the IP network;
performing a map procedure that includes parsing the plurality of advertisement requests to construct a first table having records indexed by the identity of the publisher and values that are at least the geolocation data;
performing a reduce procedure that includes reading the first table and performing a plurality of tests on the values stored therein, and constructing a second table having records indexed by the identity of the publisher and values that indicate whether the publisher is trusted or not;
wherein a publisher is trusted if each one of the plurality of tests is passed for all of the records in the first table corresponding to that publisher.

2. The method of claim 1, in which:
each advertisement request further comprises a country of origin of the advertisement request;
the map procedure includes storing in each record the country of origin of the advertisement request; and
the reduce procedure carries out, on each record, a lookup on the geolocation data to identify an actual country that the data correspond to and further stores the actual country in the record.

3. The method of claim 2, in which the reduce procedure carries out a first test comprising counting, for each publisher, the number of countries in its advertisement requests that do not correspond to the actual countries identified in the lookup.

4. The method of claim 3, in which a publisher passes the first test if passes if 15 percent or fewer countries in its advertisement requests do not correspond to the actual countries identified in the lookup.

5. The method of claim 2, in which the reduce procedure carries out a second test comprising counting, for each publisher, the instances of geolocation data not resolving to actual countries

6. The method of claim 5, in which a publisher passes the second test if there are 30 percent or fewer instances of geolocation data not resolving to actual countries. 15

7. The method of claim 2, in which the reduce procedure carries out a third test comprising, for each record:
swapping the latitude and longitude in the geolocation data to produce swapped geolocation data;
performing a lookup on the swapped geolocation data to identify an actual country that the swapped geolocation data correspond to; and
comparing the actual country to the country stored in each record.

8. The method of claim 7, in which a publisher passes the third test if 15 percent or fewer actual countries identified using the swapped geolocation data do not correspond to the countries in its advertisement requests.

9. The method of claim 2, in which the reduce procedure carries out a fourth test comprising, for each record, comparing the geolocation data to the latitude and longitude of the centre of the actual country the geolocation data correspond to.

10. The method of claim 9, in which a publisher passes the fourth test if there are 5 percent or fewer instances of geolocation data being the centre of the actual country the geolocation data correspond to.

11. The method of claim 1, in which the reduce procedure performs a fifth test comprising identifying, for each record, whether the geolocation data correspond to the equator or the Greenwich meridian. 10

12. The method of claim 11, in which a publisher passes the fifth test if 5 percent or less of the geolocation data in its advertisement requests do not correspond to either the equator or the Greenwich meridian.

13. The method of claim 1, in which the reduce procedure performs a sixth test comprising identifying, for each record, whether the latitude and longitude in the geolocation data are symmetric.

14. The method of claim 13, in which a publisher passes the sixth test if 5 percent or less of the latitude and longitude in the geolocation data are symmetric.

15. The method of claim 1, in which the reduce procedure performs a seventh test comprising, for each record in the first table, counting decimal places in the geolocation data.

16. The method of claim 15, in which a publisher passes the seventh test if 75 percent or more of the geolocation data in its advertisement requests have at least 3 decimal places.

17. The method of claim 1, in which:
each advertisement request further comprises an identifier identifying the device from which the advertisement request originated;
the map procedure includes storing in each record the identifier from the advertisement request; and
the reduce procedure performs an eighth test comprising counting the number of unique identifiers in the first table.

18. The method of claim 17, in which a publisher passes the eighth test if there is more than one unique identifier, and there are more than 100 records that have different geolocation data and have an identifier.

19. The method of claim 1, in which the reduce procedure performs a ninth test comprising inspecting the name of the publisher in each record.

20. A non-transitory computer-readable medium having computer-readable instructions encoded thereon, in which said computer-readable instructions, when executed by a computer, cause the computer to perform a method comprising validating geolocation data received via an Internet Protocol (IP) network, the method comprising:
receiving a plurality of advertisement requests via the IP network, each one of which is received from a respective one of a plurality of publishers connected to the IP network, and wherein each of the plurality of advertisement requests comprises at least the identity of the publisher, and geolocation data comprising the latitude and longitude of a device requesting a resource from the publisher over the IP network;
performing a map procedure that includes parsing the plurality of advertisement requests to construct a first table having records indexed by the identity of the publisher and values that are at least the geolocation data;
performing a reduce procedure that includes reading the first table and performing a plurality of tests on the values stored therein, and constructing a second table having records indexed by the identity of the publisher and values that indicate whether the publisher is trusted or not;
wherein a publisher is trusted if each one of the plurality of tests is passed for all of the records in the first table corresponding to that publisher
